(19) United States
(12) Patent Application Publication
(10) Pub. No.: US 2024/0311928 A1
(43) Pub. Date: Sep. 19, 2024

(54) ONLINE DISCUSSION FORUMS SUPPORTING DECENTRALIZED AUTONOMOUS ORGANIZATIONS

(71) Applicant: Alpha Exploration Co. d/b/a Clubhouse, San Francisco, CA (US)

(72) Inventors: John MILINOVICH, Campbell, CA (US); Akshaan KAKAR, New York, NY (US); Paul DAVISON, Mill Valley, CA (US); Rohan SETH, Oakland, CA (US)

(73) Assignee: Alpha Exploration Co. d/b/a Clubhouse, San Francisco, CA (US)

(21) Appl. No.: 18/121,130

(22) Filed: Mar. 14, 2023

(51) Int. Cl. G06Q 50/00

(52) U.S. Cl. CPC G06Q 50/01

(57) ABSTRACT

An online discussion forum (ODF) system includes processing circuitry configured to create and deploy a smart contract to a blockchain that establishes a decentralized autonomous organization (DAO) associated with a community with at least one of the ODF participants identified as a managing member, and associate a treasury with the DAO into which payments of the membership fee are deposited, receive a proposal from one of the platform clients to make a payment from the treasury to a recipient, in response to receiving the proposal to make a payment from the treasury to the recipient, send, to the platform client of the managing member of the DAO, a request for a vote on whether to approve the proposal, receive a reply message containing information on the vote from the platform client of the managing member, and determine whether to make the payment according to the proposal based on the vote.

### TECHNICAL FIELD

The present disclosure relates to online discussion forums, decentralized autonomous organizations and the intersection of those fields.

### BACKGROUND

Online discussion forums (ODF(s)), sometimes referred to as social media, provide mechanisms by which people of all stripes can communicate ideas and share interests amongst themselves. Modern ODFs, e.g., TWITTER, FACEBOOK, YOUTUBE, etc., can accommodate tens of millions of users and millions of interactions therebetween and thereby provide a robust environment for exchanging ideas, information, interests, etc. As with any society, certain ODF users that may have expertise in some area of interest, be entertaining or artistic and/or have other appealing qualities may attract other ODF users, often in great numbers. In certain implementations, ODF users may associate themselves according to, for example, area of interest, and attractive ODF users described above, e.g., journalists, entertainers and other artists, etc., may be included in such an association and may even be its principal member. Certain ODFs may allow users to charge a fee for each such association. For example, a journalist having a large following or readership may provide exclusive content to those willing to pay that fee. Research and engineering efforts towards flexible ODF monetization are ongoing.

### SUMMARY

In one aspect of the inventive concept, an online discussion forum (ODF) system is under operational control of a platform operator to allow discussion participants to interact over a telecommunications network. User terminals are communicatively coupled to the telecommunications network, and each executes a platform client by which submissions are composed by the corresponding discussion participants. Processor circuitry communicatively coupled to the user terminals through the telecommunications network is constructed to construct a computer-readable contract in response to a command issued from the platform client of an initiating one of the discussion participants. The command establishes a decentralized business entity and the contract includes computer-executable instructions that enforce its terms on interactions between the platform clients and the business entity. The contract terms include requirements for membership into a closed community of discussion participants, fulfillment of which being verified by the computer-executable instructions enforcing the terms of the contract and includes payment of a membership fee to the business entity for inclusion into the closed community of discussion participants. A treasury account is established for the business entity into which the payment of the membership fee is deposited and transactions with the treasury account are recorded in a computer-readable ledger. A membership token is issued to each of the discussion participants in accordance with the contract in response to acknowledgement that the corresponding payment of the membership fee has been recorded in the computer-readable ledger. The submissions composed on the platform clients are exchanged in separate online discussions that are segregated to exclude participation in online discussions between the member discussion participants to only those discussion participants in possession of the membership token.

In another aspect of the inventive concept, an ODF system allows discussion participants interact over a telecommunications network. An ODF server is constructed to execute an interface into a virtual machine that is constructed to execute bytecode enforcing terms of a smart contract. User terminals are each constructed to execute a platform client through which the terms of the smart contract are established by an authorized discussion participant on the ODF server over the telecommunications network. A platform processor executing on the ODF server is communicatively coupled to the platform client at each of the user terminals through the telecommunications network and allows a selected group of discussion participants to transact in an online discussion as established in the terms of the smart contract.

In yet another aspect of the present inventive concept, an ODF process includes executing instructions compliant with a first instruction set architecture on a platform processor that accepts designation of members of a business entity from a platform client and of a membership fee for access to an exclusive ODF discussion community from the platform client. The platform processor instructions construct a contract containing instructions compliant with a second instruction set architecture of a virtual machine. The contract includes contract terms derived from the accepted designation of the members of the business entity and the designation of the membership fee. The platform processor instructions allow the access to the exclusive ODF discussion community by another platform client in possession of a membership token. The ODF process includes executing the instructions compliant with the second instruction set architecture on the virtual machine that accepts a membership request from the other platform client through the platform processor and issues the membership token to the other platform client in response to the membership request meeting the contract terms in the contract.

### BRIEF DESCRIPTION OF THE DRAWINGS

FIG. 1 is a conceptual block diagram demonstrating exemplary features of an embodiment of the present general inventive concept.

FIG. 2 is schematic block diagram of an exemplary embodiment of the present general inventive concept.

FIG. 3 is a schematic flow diagram of exemplary paid house construction process by which a paid house and associated DAO may be formed in accordance with the present inventive concept.

FIG. 4 is a flow diagram of an exemplary online discussion platform process by which the present inventive concept may be embodied.

FIG. 5 is a schematic block diagram of an exemplary embodiment of the general inventive concept.

FIG. 6 is a schematic block diagram of an exemplary online discussion platform by which the present general inventive concept can be embodied.

FIG. 7 is a sequence diagram of an exemplary meta-transaction by which embodiments of the present inventive concept may be embodied.

FIG. 8 is a flow diagram of an exemplary meta-transaction by which embodiments of the present inventive concept may be embodied.

### DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the terms inventive concept and invention, when used herein, are intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

The figures described herein include schematic block diagrams illustrating various interoperating functional modules. Such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

The techniques described herein are directed to online discussion forums (ODF(s)) having decentralized management capability of which individual groups in the ODF can avail themselves. Upon review of this disclosure and appreciation of the concepts disclosed herein, the ordinarily skilled artisan will recognize other online community contexts in which the present inventive concept can be applied. The scope of the present invention is intended to encompass all such alternative implementations.

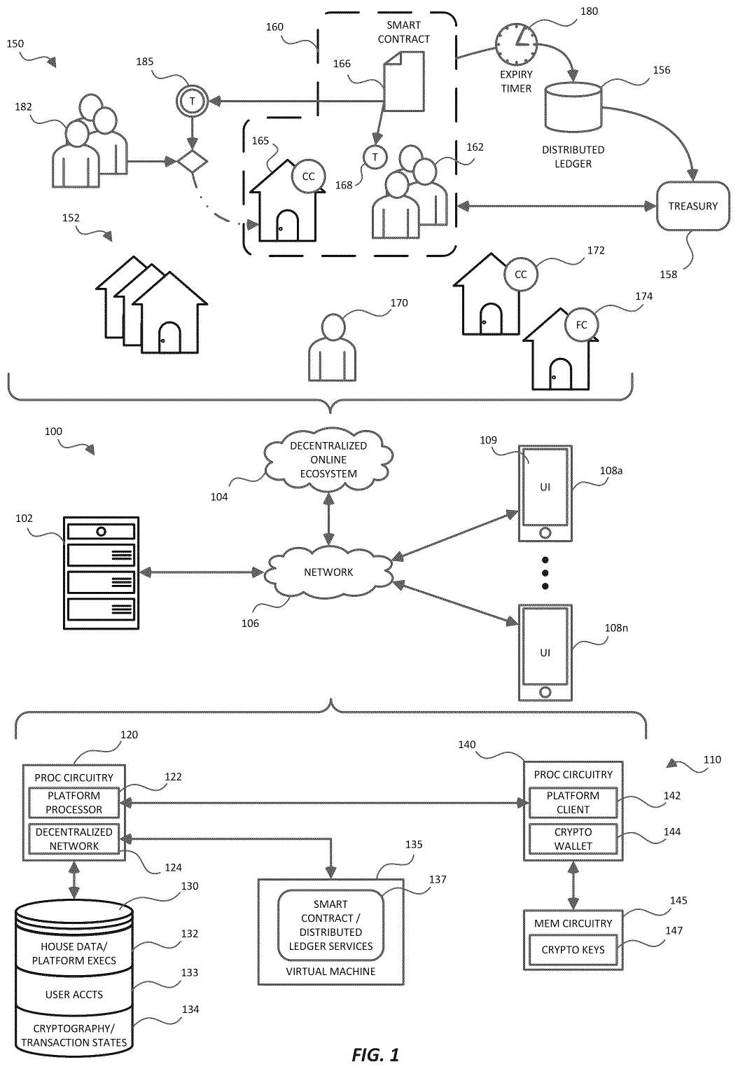

FIG. 1 is a conceptual block diagram demonstrating exemplary features of an embodiment of the present general inventive concept. An ODF system 100 may afford telecommunications between one or more user terminals 108a-108n, representatively referred to herein as user terminal(s) 108, and centralized computational resources, such as on a server 102, over a telecommunications network 106. Such telecommunications may be achieved over widely available and well-known telecommunication equipment, signaling standards and data transfer protocols. For example, network 106 may comprise wireless (e.g., cellular, Wi-Fi, etc.) and wired (e.g., backbone, ethernet, etc.) network architecture segments that are selectively interconnected in, for example, an end-to-end Transmission Control Protocol/Internet Protocol (TCP/IP) connection. However, ODF system 100 may be additionally constructed or otherwise configured to access a decentralized online ecosystem 104 defining communication, data transfer and information storage protocols by which, among other things, decentralized autonomous organizations (DAO(s)) can be formed by users at user terminals 108.

As illustrated in FIG. 1, an ODF platform 110 may be constructed or otherwise configured from computational and data storage resources of ODF system 100. As used herein, the term “platform” is intended to refer to the interoperating assemblage of data processing hardware, processor instructions (software) that execute on the data processing hardware to achieve a goal of the platform, e.g., affording online discussions, and memory hardware constructed to store platform related data and the processor instructions. The computational and data storage resources of ODF system 100 that are brought to bear in formation of ODF platform 110 may include, for example, processor circuitry 120 and memory circuitry 130 on server 102, and processor circuitry 140 and memory circuitry 145 at each user terminal 108. It is to be understood that ODF platform 110 may be operated under the aegis of one entity, referred to herein as a platform operator, that is independent of another entity who owns, operates or is otherwise responsible for maintaining operational readiness of server 102 on which efficient operations of ODF platform 110 may rely.

Processor circuitry 120 may execute a platform processor 122 by which participants of ODF platform 110 can interact and participate in an ODF 150. As used herein, the term “forum,” as in online discussion forum 150, is intended to refer to a processor implemented virtual environment achieved by, for example, ODF platform 110, that may include metaphoric features, e.g., houses, walking paths, etc., by which forum participants interact with one another within the virtual environment and, in some implementations, forum participants may interact with virtual objects within that environment. Processor circuitry 120 may also be constructed or otherwise configured to execute a decentralized network interface 124 by which ODF platform 110 avails itself of features of decentralized online ecosystem 104 that require execution of a virtual machine 135, such as smart contract and distributed ledger (e.g., blockchain) services 137, for implementing smart contract 166 and distributed ledger 156. Processor circuitry 120 may be communicatively coupled to memory circuitry 130 in which are stored house data/platform executives 132. As used herein, the term “house” is intended to refer to a combination of processor instructions (software) executing on processor circuitry and associated data for an interactive functional component that is represented in a virtual environment as a house (dwelling) and may include subcomponents such as entrances, exits, rooms and hallways. In such a house, online discussions are conducted that may include textual, graphical, audio and video information being transferred in some way consistent with the virtual environment (text bubbles, live audio spectra, etc.). ODF platform 110 may realize the online discussions by analyzing, segregating and assembling submissions composed on platform clients 142 into individual discussion streams, such as by platform processor 122, and presenting the discussion in the virtual environment as being conducted in the corresponding house. In certain embodiments, such online discussions occur over audio signals and data, such as those described in U.S. patent application Ser. No. 17/875,742 filed on Jul. 28, 2022, entitled, “FEATURES FOR ONLINE DISCUSSION FORUMS,” incorporated by reference as being fully set forth herein, but the concept described herein may be embodied for other interaction techniques, e.g., textual, graphical, video, without departing from the spirit and intended scope thereof.

House data/platform executives 132 in combination with the processing circuitry of platform processor 122 may realize the bulk functionality of an online discussion forum as well as the inventive concepts that are described herein. Platform executives, for example, may include computer program code for platform services, such as those described herein, while house data, for example, may include data structures by which the various houses, paid and gratis, are defined, including, for example, the house name, the house discussion topic and/or discussion host, house appearance and/or house founder preferences, public house member names, etc., as well as information about the house that can be indexed and made searchable by both external search engines and locally implemented search tools. For paid houses, such as those described herein, such house data may include membership requirements, such as the cost of membership.

In addition to house data/platform executives 132, memory circuitry 130 may be constructed or otherwise configured to store user account information 133 that may include user identifying information, user preferences that may include membership and subscription information, wallet addresses, etc. Further, cryptographic/transaction states 134 may include program code for cryptographic methods, including that for decentralized network interface 124, and transaction states of meta-transactions 133, as is exemplified below.

Processor 140 on each user terminal 108 may execute a platform client 142 communicatively coupled to platform processor 122 that affords user participation in ODF 150, as discussed below. Processor 140 may also execute a cryptocurrency wallet 146 that controls access to cryptographic keys 147 stored in memory circuitry 145 communicatively coupled thereto. Cryptographic keys 147 may be used in certain transactions, particularly those involving targets in decentralized online ecosystem 104, examples of which are described herein.

As indicated above, ODF 150 may utilize representations of users and interactions between users in accordance with a theme of an artificial or virtual environment. In addition to their implementation details provided above, houses may be viewed as the confines of a segregated (e.g., by discussion topic, discussion host, etc.) community of online discussion participants in which user communities can congregate and interact in groups as might occur in a “brick-and-mortar” clubhouse. In FIG. 1, a user 170, referred to herein as a platform member, can associate itself with one or more free houses 152 and thereby interact with other users associated therewith without charge. ODF 150 may also include paid houses by which users can monetize their ODF content. Such paid houses may accept payment by fiat currency (FC), representatively illustrated at paid house 174, and/or cryptocurrency (CC), representatively illustrated at paid house 172.

As illustrated in FIG. 1, a paid house, representatively illustrated at paid house 165, may be organized and managed under a decentralized autonomous organization (DAO), representatively illustrated at DAO 160. That is, from a business point of view, paid house 165 may be viewed as a product or service offered by DAO 160 for the purpose of generating revenue. Functionally, paid house 165 may implement features in common with those of other houses on ODF 150, but with additional features by which paid house 165 can be operated and managed under DAO 160. As will be described in more detail below, ODF platform 110 may be constructed or otherwise configured to associate a DAO treasury 158 with DAO 160 into which revenue generated by paid house 165 may be deposited. As used herein, the word “deposit” is intended to include cryptocurrency implementations in which the “deposit” is little more than an entry in a distributed ledger such as a blockchain, e.g., distributed ledger 156. Among the benefits that can be achieved when the present inventive concept is practiced is the full management capability over DAO treasury 158 by the token holding members of DAO 165, representatively illustrated at DAO members 162. For example, a proposal for discretionary spending from DAO treasury 158 may be generated and submitted for a vote by DAO members 162, where the vote by each DAO member 162 may be weighted by that member's holding of ownership tokens 168.

The business operations of DAO 160 may be defined in a smart contract 166 agreed upon by DAO members 162. Smart contract 166 may comprise bytecode that may be executed on virtual machine 135 in response to corresponding execution conditions encoded thereon being met. Smart contract 166 may be stored in distributed ledger 156, an operation that itself requires execution time of virtual machine 135 thus affecting transaction fees known as “gas.” Transactions with DAO 165 may be processed for execution by virtual machine 135 and recorded in distributed ledger 156 and, upon the execution conditions defined in smart contract 166 being met, a corresponding action defined in bytecode may be executed by virtual machine 135. Such virtual machine executed actions may include, among other things, transferring fungible tokens, e.g., cryptocurrency, between DAO members 162 and DAO treasury 158 associated therewith, issuing fungible tokens, e.g., ownership tokens 168 by which DAO members 162 vote over the direction of DAO 160 and issuing nonfungible tokens (NFT(s)), e.g., membership tokens representatively illustrated at membership token 168, upon payment of a membership or subscription fee paid by platform members 182 (this operation is often described as the platform member 182 purchasing the NFT membership token 185). As illustrated in FIG. 1, only those platform members 182 in possession of membership token 185 are permitted entry into paid house 165, at which time they may be referred to as paid house members. It is to be understood, however, that membership in a paid house need not be associated with membership tokens, per se; membership may be indicated through a suitable data base entry, such as in user accounts 133.

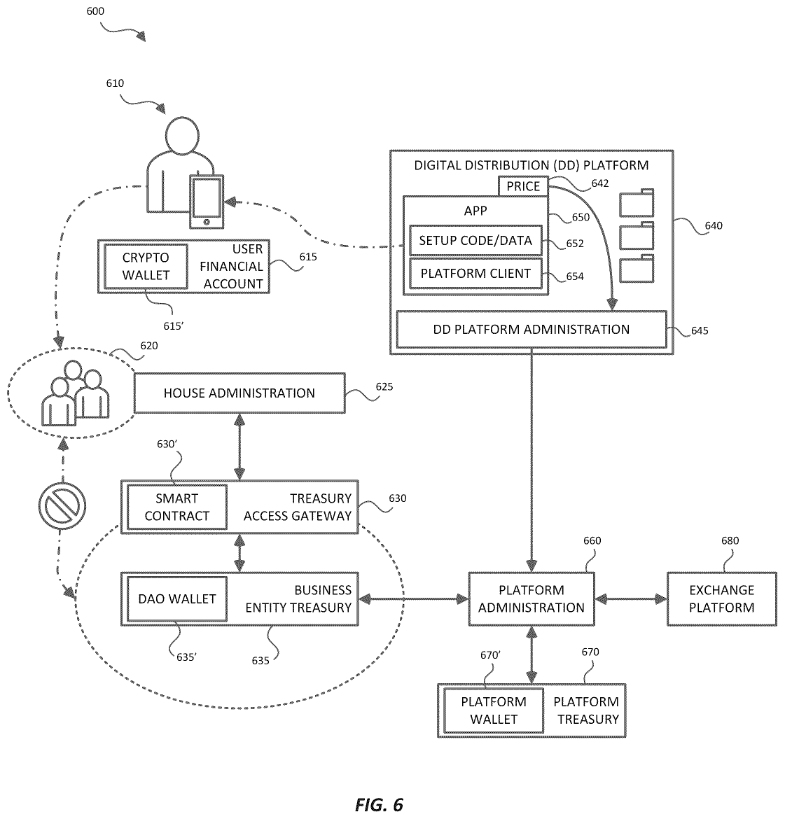

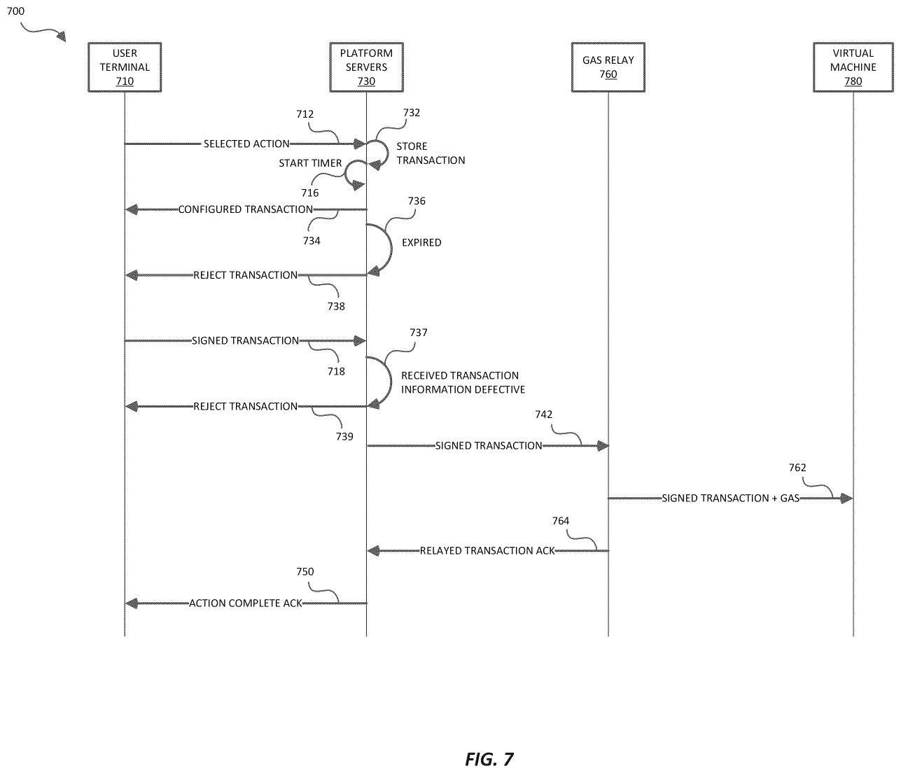

Certain transactions may have a desired expiration time, which may be monitored by a transaction expiry timer 180. Such transactions are demonstrated through the descriptions of FIGS. 6 and 7.

In certain embodiments, users may be assigned to different tiers of a user hierarchy, such as, for example, from highest in the hierarchy to lowest, DAO founders that establish a paid house, which, as used herein, refers to a closed community of online discussion participants that have paid a membership fee to DAO 160, DAO administrators designated by the DAO founders to perform administrative functions of DAO 160, house members that are associated with respective houses on ODF 150 and platform members unassociated with houses on ODF 150 but that are registered with the platform. Various implementations may enforce inherency by which users assigned to higher tiers of the hierarchy are afforded at least the functionality implemented in the lower tiers. Upper tiers of the hierarchy may be assigned greater privileges than lower tiers, such as having authorization for conducting management functions that are beyond routine online discussion functions. It is to be understood that other hierarchies establishing other functionality on its different tiers may be used without departing from the spirit and intended scope of the present inventive concept.

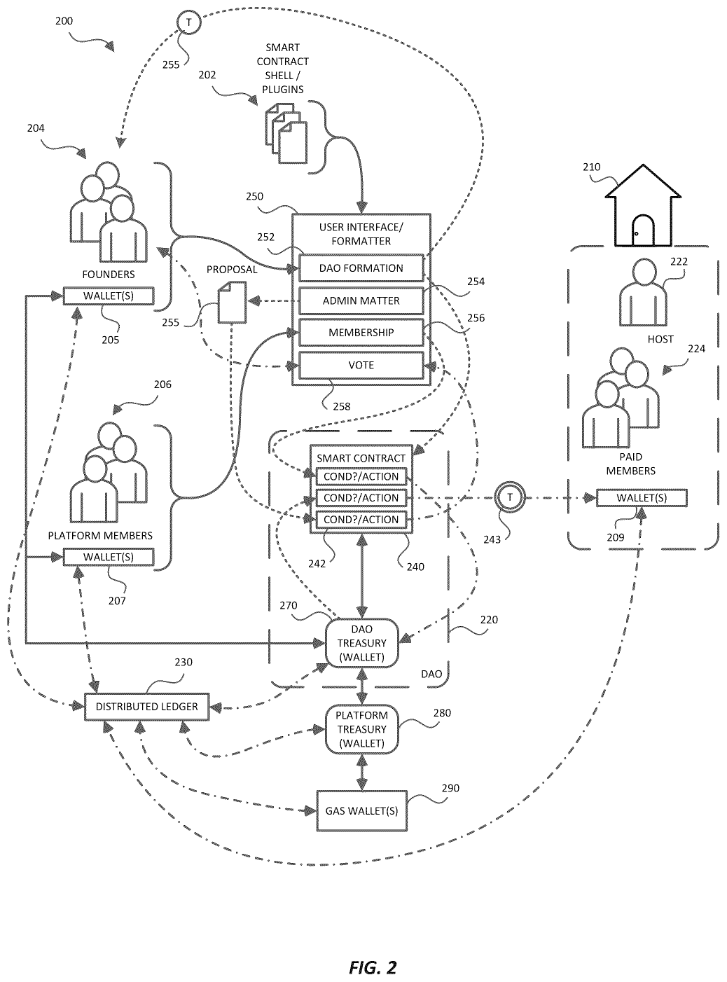

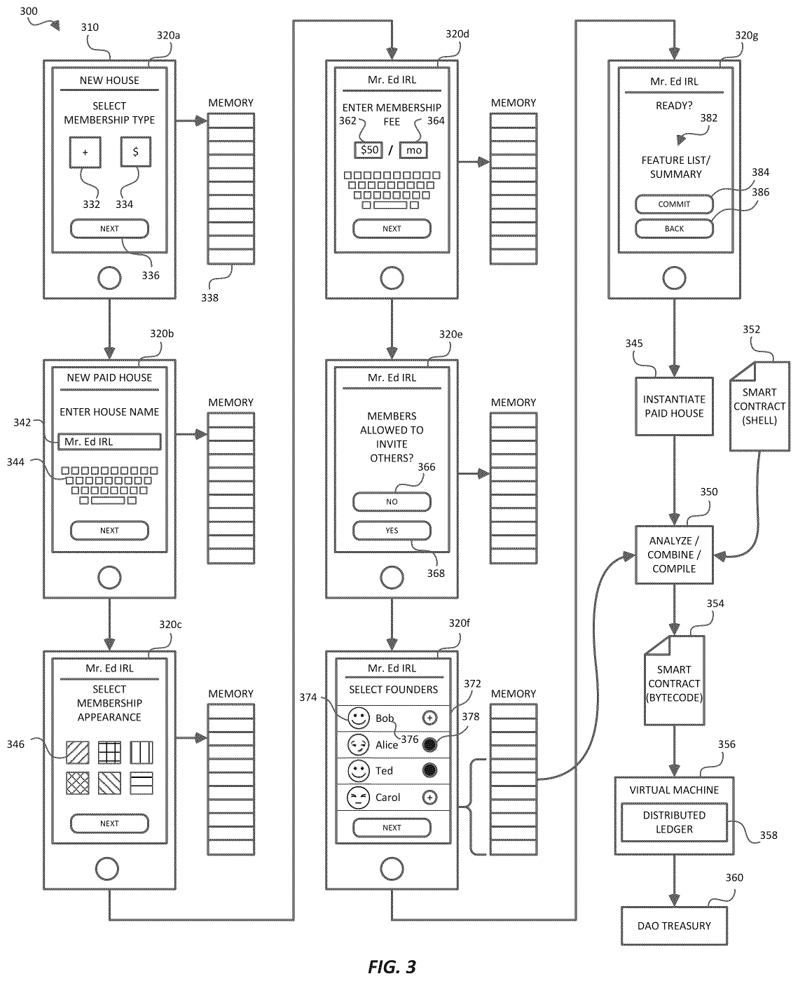

FIG. 2 is schematic block diagram of an exemplary ODF 200 by which the present inventive concept can be embodied. ODF 200 may include a user interface/formatter (UIF) 250 supported by mechanisms of ODF platform 110. Exemplary UIF 250 represents mechanisms deployed at and/or distributed over each user terminal 108, server 102 and decentralized online ecosystem 104 by which users 170 can select options, form communities, engage in token-based transactions, visualize results, etc. For example, UIF 250 may comprise a user interface 109 implemented as a component of platform client 142 at each user terminal 108, user interface 109 having user interface controls, such as those described with reference to FIG. 3, the format, content and presentation of which may be established using well-known client/server messaging techniques. Additionally, exemplary UIF 250 further represents mechanisms that may be deployed at and/or distributed over each user terminal 108, server 102 and decentralized online ecosystem 104 by which user entries made through platform client 142 are suitably formatted and compiled, where necessary, for execution by virtual machine 135.

For purposes of demonstration and not limitation, it is to be assumed that a group of users of ODF 200 agree to establish a paid house 210 in which exclusive online discussions are conducted between a host 222 and a community of users, representatively illustrated at paid house members 224, as described herein. That is, paid house 210 may be viewed as containing a closed or otherwise exclusive community of discussion participants, e.g., paid house members 224 and host 222, and inclusion into that closed community may be granted on an extended basis, such as by payment of a membership or subscription fee to paid house 210 or, more accurately, to DAO treasury 270. Inclusion into the closed community may also be granted on a short-term or immediate basis, such as by being invited to join by paid house members 224 in a particular event/online discussion, and by purchasing a single-use ticket into paid house 210 for a particular event/online discussion.

As discussed above, paid house 210 may be considered a product and/or service of a business entity, e.g., the associated DAO 220, and is typically provided as such by the business entity to generate revenue, for example. DAO 220 may be organized under a smart contract 240, which may define terms that include the manner in which funds in DAO treasury 270 are managed.

In certain embodiments, paid house 210 may be established through a sequenced set of data entry interface controls presented to the initiating platform member, e.g., one of founders 204, such as those described with reference to FIG. 3. DAO formation component 252 of UIF 250 may obtain the entered information by the initiating platform member and may subsequently build smart contract 240 therefrom combined with data contained in one or more smart contract shells 202. Smart contract shells 202 may include source code for virtual machine executable management functions, different smart contract options establishing execution conditions/thresholds in response to which the virtual machine executable management functions are executed by a virtual machine, such as virtual machine 135 illustrated in FIG. 1. Once the appropriate smart contract options have been selected, such as through the sequenced set of data entry interface controls described with reference to FIG. 3, DAO formation component 252 may assemble the entered data and applicable smart contract shells 202, may compile, where necessary, source code included in one or more of the smart contract shells 202 into bytecode, and may submit the resulting smart contract 240 to virtual machine 135 for recording into distributed ledger 230, a process requiring virtual machine execution time, which may be used as a metric on which transaction fees known as “gas” are calculated.

As illustrated in FIG. 2, users of ODF 200 may be associated with respective cryptographic wallets, referred to herein as crypto wallet(s) and representatively illustrated at: crypto wallet(s) 205 associated with respective founder(s) 204, crypto wallet(s) 207 associated with platform member(s) 206 and crypto wallet(s). Each of these crypto wallets 205, 207 and 209 may provide access to, for example, public and private cryptographic keys by which the wallet owner (or, more accurately, the wallet possessor) can transact with smart contract/distributed ledger services 137 through virtual machine 135, where such transactions include digital signing, transferring or otherwise exchanging fungible and non-fungible tokens, and so on. Additionally, ODF 200 may include one or more gas wallets 290 from which gas may be paid in meta-transactions, such as those described below with reference to FIGS. 6 and 7. DAO formation component 252 may be provided cryptographic keys from crypto wallets 205 for every founder 204 of paid house 210, such as for digitally signing and distribution of shares from DAO treasury 270 of DAO 220. DAO formation component 252 may be constructed or otherwise configured to establish DAO 220 in ODF 200, including, among other things, creating and funding DAO treasury 270, distributing and/or exchanging fungible and non-fungible tokens in transactions using crypto wallet(s) 205 and storing smart contract 240 on a distributed ledger 156, such as blockchain. Once DAO 220 becomes active, users may transact with DAO 220 through logical operations 242 defined in smart contract 240, where the logical operations 242 include conditional execution of actions selected by founders 204, such as those described below.

One exemplary feature that can be implemented in embodiments of the inventive concept is the acceptance of paid membership into paid house 210. To that end, UIF 250 may have a membership component 256 through which a potential member from platform members 206 may apply for membership into paid house 210. Membership component 254 may be constructed or otherwise configured to convey a request for membership to virtual machine 135 where it is evaluated against logical operations 242 established in smart contract 240 by founders 204. A trigger condition in logical operations 242 of smart contract 240 may be assigned to the membership request, that, when met, may execute an associated action that transfers a membership fee from the crypto wallet 207 of the potential member from platform members 206 to the crypto wallet of DAO treasury 270. The transfer may be associated with another trigger condition, e.g., the transfer of the membership fee to DAO treasury 270, compelling execution of the corresponding action by virtual machine 135. Such action may include the transfer of a membership token, such as a nonfungible token, to crypto wallet 209 of the paid house member 224. In certain embodiments, only those platform members 206 in possession of membership token 243, i.e., paid house members 224, are allowed access into paid house 210. In addition to the transfer of the membership fee between platform user wallets 207 and DAO treasury wallet 280, an additional transfer from DAO treasury wallet 270 to platform treasury wallet 280 as described further below.

In certain embodiments, UIF 250 may include an administrative matter component 254 by which matters requiring a vote of house founders 204 (and designated house administrators) are addressed. Such matters may include, among other things, approval of dispersal of funds from DAO treasury, amendments to smart contract 240, such as through suitable plugins 202 that are executable by virtual machine 135, approving paid house membership, and so on. In certain embodiments, administrative matter component 254 may format a suitable proposal 255 that defines the matter up for a vote and may convey proposal 255 to virtual machine 135 where it may be evaluated against logical operations 242 in smart contract 240. In response to proposal 255 meeting a trigger condition in smart contract 240, such as by recognizing the issue up for a vote, the associated action may compel the display of a vote control on user interface 109 through the corresponding platform client 142 at the relevant user terminals 108 that is appropriate to the subject of the vote. Vote component 256 may tally votes entered through the vote controls of participating voters, which may include weighting votes according to the number of membership tokens 255 under the control of the different voters. Moreover, vote component 258 may be constructed or otherwise configured to override votes of other voting members at the behest of one or more founders 204.

Embodiments of the inventive concept may allow token transfers between DAO treasury 270 and platform treasury 280 according to terms established in smart contract 240. For example, operators of ODF platform 110 may expect a percentage stake in every paid house 210 constructed on the platform. When so embodied, a logical operation 242 in smart contract 240 may be triggered on certain transactions by which the platform operator's stake is transferred from DAO treasury 270 to platform treasury 280. Additionally, transaction fees referred to as gas and payable to miners/minters of distributed ledger 156 may be withdrawn from a crypto wallet 290 designated specifically for paying gas in meta-transactions, such as those described with reference to FIGS. 6 and 7.

FIG. 3 is a schematic flow diagram of exemplary paid house construction process 300 by which a paid house and associated DAO may be formed in accordance with the present inventive concept. The figure demonstrates process 300 through a sequence of user interface (UI) pages 320a-320g, collectively referred to herein as UI pages 320, each presenting user-selectable options defining features of the paid house as realized within the ODF. UI pages 320 may be presented on user terminal 310, such as through a platform client 142 executing thereon, and the selected options may be transmitted to platform processor 122 over telecommunications network 106.

In the illustrated example of FIG. 3, paid house construction process 300 may begin with the presentation of UI page 320a by which the initiating platform member, i.e., the platform member who initiates paid house construction process 300, can select the type of house to create. The initiating platform member may be a house founder but need not be. In certain implementations, the founders may agree to create a paid house 210 (and associated DAO 220) in an online discussion in another house on ODF 150 and the initiating platform member may simply be a representative for the group. The initiating platform member may activate UI control 332 to create a free house while activation of UI control 334 may compel the creation of a paid house 210. For purposes of the remaining description of process 300, it is to be assumed that the initiating platform member activates UI control 334 to create paid house 210. Data representing the selection may be stored in memory circuitry, representatively illustrated at memory 338. Activation of UI control 336 may compel the presentation of the next UI page in the series, e.g., UI page 320b, by which the initiating platform member can assign a name to paid house 210. To that end, UI control 342 may be configured for textual entry of data, which may be provided through activation of UI control 344, e.g., a keyboard. The chosen name may be stored in memory 338 as illustrated in the figure. Paid house construction process 300 may then proceed to present UI page 320c by which the initiating platform member can select the appearance of a membership token, e.g., an NFT. For example, UI page 320c may have an array of tiles, representatively illustrated at UI control 346, demonstrating different appearance options, data indicating the selected one of which may be stored in memory 338. In the next page, e.g., UI page 320d, the initiating platform member may enter a membership fee for entry in the pending paid house 210. In the illustrated example, a first UI control 362 may accept a fee amount, in either fiat currency or cryptocurrency, and UI control 364 may accept the fee term, from, for example, a daily rate to an annual one. This data, $50.00/month in the illustrated example, may also be stored in memory 338. Paid house construction process 300 may then present UI page 320e by which the decision can be made as to whether paid house members are allowed to invite other platform members (including members in other houses, both paid and gratis) into paid house 210 (upon payment of the membership fee), in which case the initiating platform member would activate UI control 368. Alternatively, the initiating platform member may activate UI control 366 and require membership to be approved by house management, e.g., house founder and/or house administrator members of DAO 220. Data indicative of the selection may be stored in memory 338 as illustrated in FIG. 3. Paid house construction process 300 may present UI page 320f by which the initiating platform member can select the founding members of paid house 210, which may also serve as voting members of DAO 220. To that end, UI page 320f may include one or more member fields, representatively illustrated at member field 372, in which member information is portrayed, such as, for example, a user image, avatar, icon, etc., representatively illustrated at user avatar 374, and a username or handle, representatively illustrated at user handle 376. UI control 378 in each member field 372 may be provided to select the user described in that member field 372 as a founding member. Data indicating the selected founding members may be stored in memory 338.

It is to be understood that UI pages 320 described above are members of but one exemplary set of UI controls by which house options can be selected by a user. Other options, both in online discussion (forum) aspects and in business (DAO) aspects, can be made selectable in manner similar to that described above. Additionally, UI pages 320 may be presented in an order other than that illustrated in FIG. 3 without departing from the inventive concept described herein. When all options have been selected and respective data indicative of such have been stored in memory 338, UI page 320g may be presented by which the initiating platform member can review the selected options, such as through a feature list/summary 382. If feature list/summary 382 is incorrect, the initiating platform member may activate UI control 386, in response to which platform client 142 may compel presentation of previous UI pages 320 for editing of option data. However, if feature list/summary 382 is correct to the satisfaction of the initiating platform member, he/she may activate UI control 384 to commit the selected options to the remaining operations of paid house construction process 300, which, in the exemplary embodiment illustrated, occur automatically, i.e., without further user intervention, and seamlessly to the user.

As illustrated in FIG. 3, in response to activation of UI control 384, paid house construction process 300 may transition to operation 345 by which paid house 210 is instantiated. For example, data structures of ODF 150 that persistently maintain the state of the new paid house may be initialized and stored, such as in house data/platform executives 132, functional components implemented in processor executable instructions in house data/platform executives 132 may be initialized and executed when called into the virtual environment, and so on. Paid house construction process 300 may then transition to operation 350, by which data in memory 338 are analyzed and combined with other data in a smart contract shell 352 to produce source code of a complete smart contract. Operation 350 may further compile the source code into a bytecode version of smart contract 354 which may be provided to virtual machine 356 for entry into distributed ledger 258 (blockchain, for example). Paid house construction process 300 may further transition to operation 360 by which a DAO treasury for paid house 210, e.g., DAO treasury 270, is created, such as through assignment of a cryptocurrency wallet to DAO 220 that is managed by consensus of voting house members, e.g., token-holding house founders and house administrators.

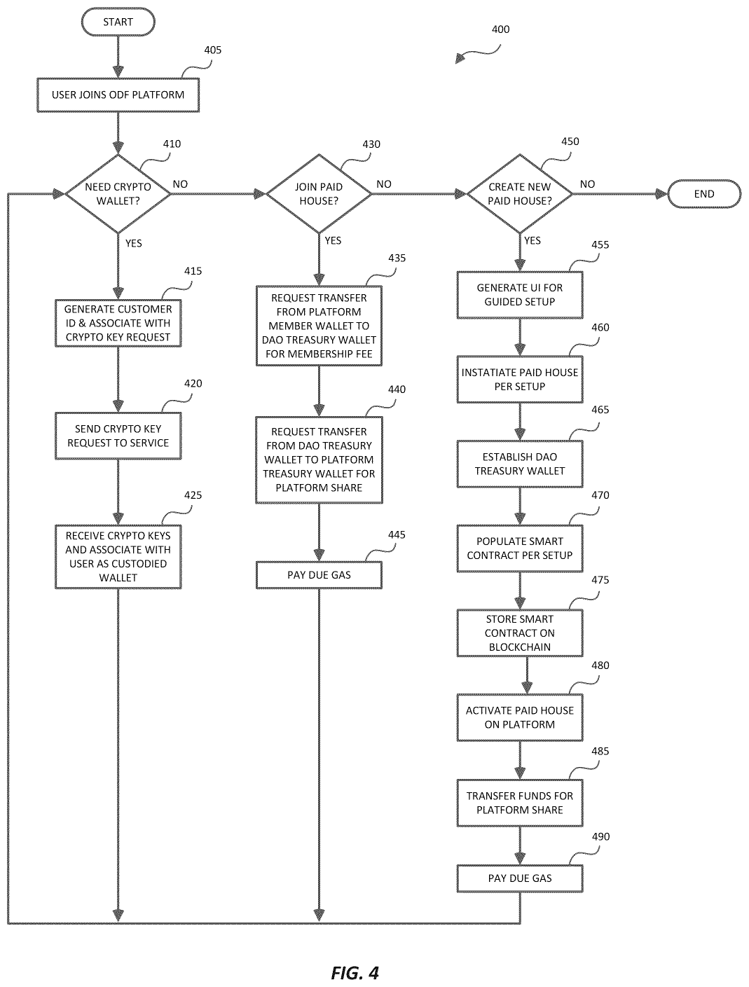

FIG. 4 is a flow diagram of an exemplary ODF process 400 by which the present inventive concept can be embodied. In operation 405, a user may join the ODF platform, thereby becoming a platform member. In operation 410, the new platform member is asked, such as by presentation of suitable UI controls on user terminal 108, whether he/she would like to set up a new cryptocurrency wallet for use on the platform. In certain embodiments, this option may be implemented to activate a wallet on the ODF platform for the platform member's use. For example, in operation 415, the ODF platform may generate a customer ID that can be associated with a request for a set of cryptographic keys. Numerous techniques exist to create a cryptocurrency wallet from public and private cryptographic keys. Additionally, services exist by which a pluggable wallet may be provided upon a suitably formatted request. In operation 420, the cryptographic key or wallet request associated with the customer ID is conveyed to the key or wallet service and, in operation 425, the ODF platform may receive the requested cryptographic keys or wallet from the key or wallet service and associate the wallet with the user for use on the ODF platform.

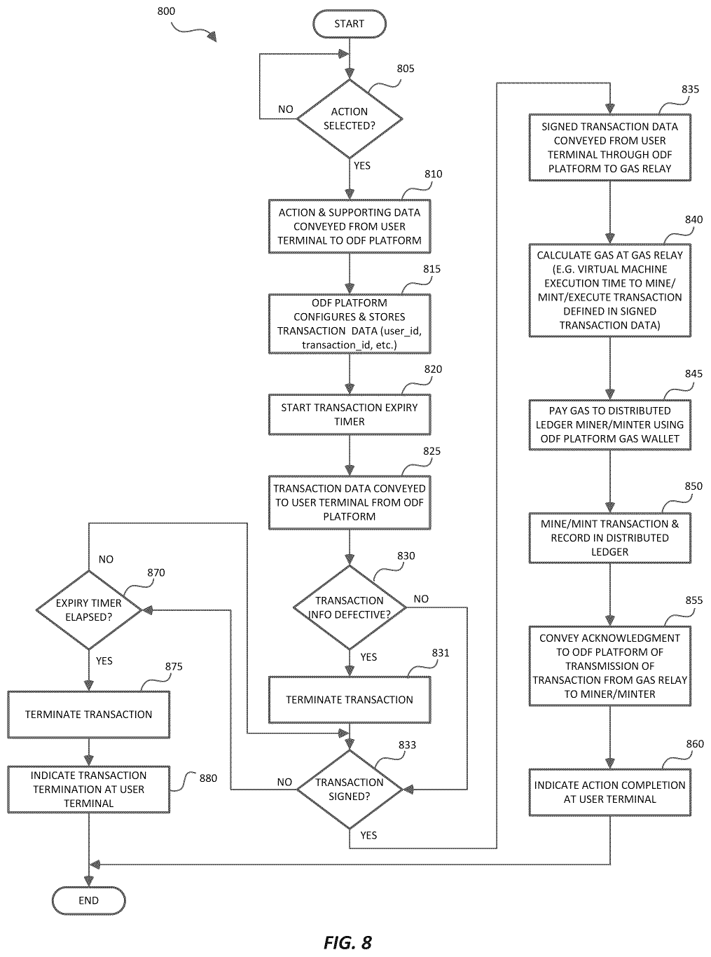

If, in operation 410, it is determined that the platform member does not require a cryptographic wallet, ODF process 400 may transition to operation 430, in which it is determined whether the platform member would like to join a paid house and become a paid house member. If so, ODF process 400 may transition to operation 435, whereby a transfer is requested in the amount of a membership fee from the cryptographic wallet of the joining platform member to the cryptographic wallet of the DAO treasury associated with the paid house to which the platform member is joining. In operation 440, a transfer is requested in the amount of a prearranged platform operator share from the cryptographic wallet of the DAO treasury to the cryptographic wallet of the platform operator. In operation 445, gas may be paid, such as from the platform treasury wallet, to the operator of the virtual machine in a meta-transaction, such as those described with reference to FIGS. 7 and 8.

If it is determined in operation 430 that the platform member is foregoing joining a paid house, ODF process 400 may transition to operation 450, by which the platform member can create a new paid house. If so, ODF operation may transition to operation 455, whereby platform client 142, for example, may generate UI components for guiding the platform member through the paid house setup, such as described with reference to FIG. 3. In operation 460, the paid house may be instantiated per the options selected during the setup process, as described above, and in operation 465, a DAO treasury wallet may be associated with the instantiated paid house. In operation 470, a smart contract shell may be populated by data entered during the paid house setup process and in operation 475, a smart contract may be stored on a blockchain or other distributed ledger that allows execution of program code. In operation 480, the paid house may be activated on the ODF platform, which may include realizing the paid house as an interactive component in the ODF virtual environment. In operation 485, the platform operator share may be transferred from the DAO treasury wallet of the paid house to the platform treasury wallet. In operation 490, gas may be paid, such as from the platform treasury wallet, to the operator of the virtual machine in a meta-transaction.

From the foregoing, skilled artisans will appreciate that embodiments of the inventive concept described herein can be viewed as comprising user terminals, e.g., user terminals 108, communicatively coupled to a telecommunications network, e.g., telecommunications network 106. Each user terminal may be constructed to execute a platform client, e.g., platform client 142, by which submissions are composed by the corresponding discussion participants. Further, embodiments of the inventive concept can be viewed as including processor circuitry, e.g., processor circuitry 130, communicatively coupled to the user terminals through the telecommunications network. The processing circuitry may be constructed to execute processor instructions, such as those stored in service executives 132, that compel the processor circuitry to construct a computer-readable contract, such as smart contract 166, in response to a command issued from the platform client, e.g., activation of commit control 384, of an initiating one of the discussion participants, that establishes a decentralized business entity, e.g., DAO 160. The contract including may include computer-executable instructions, e.g., bytecode 354, that enforce terms thereof on interactions between the platform clients and the business entity. The terms may include requirements for membership into a closed community of discussion participants, e.g., paid house members 224, which may include payment of a membership fee to the business entity. Fulfillment of the membership requirements may be verified by the computer-executable instructions enforcing the terms of the contract. The processor circuitry may be further constructed or otherwise configured to establish a treasury account for the business entity, e.g., DAO treasury 270, into which the payment of the membership fee is deposited, e.g., virtually as tracked in a computer-readable ledger, e.g., distributed ledger 260. Transactions with the treasury account may be recorded in the computer-readable ledger to which access is permitted outside control of the business entity, e.g., access being permitted by operators of virtual machine 135. Additionally, the processor circuitry may be further constructed or otherwise configured to issue a membership token, e.g., membership token 243, to each of the discussion participants in accordance with the contract in response to acknowledgement, e.g., issued by virtual machine 135, that the corresponding payment of the membership fee has been recorded in the computer-readable ledger. The processor circuitry may be further constructed or otherwise configured to exchange the submissions composed on the platform clients in separate online discussions that are segregated to exclude participation in online discussions between the member discussion participants to only those discussion participants in possession of the membership token.

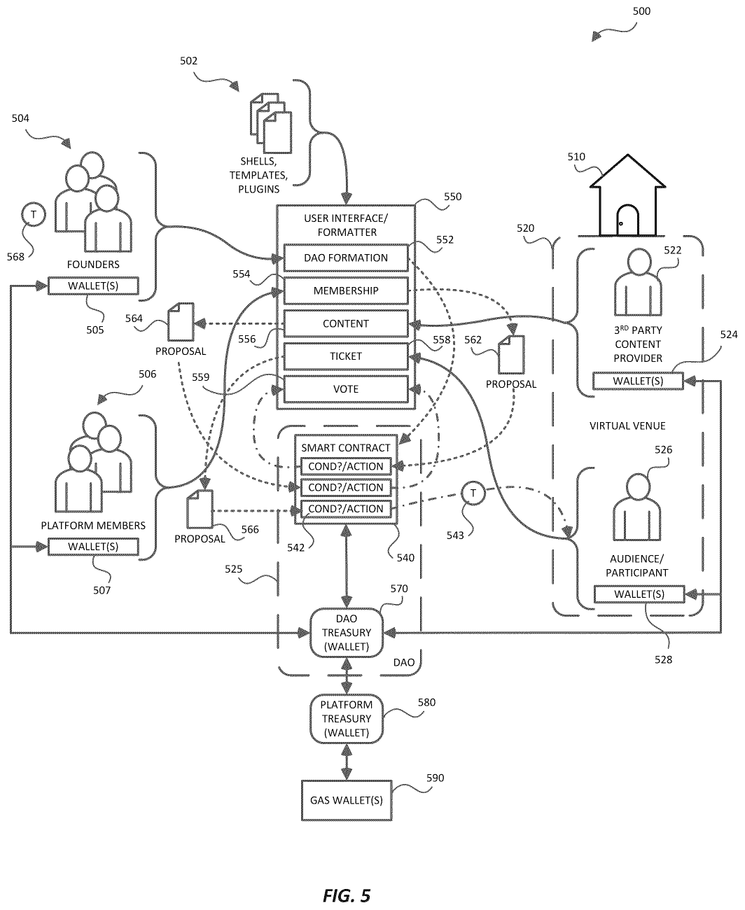

Embodiments of the invention may be constructed or otherwise configured with more elaborate functionality than that described above. FIG. 5, for example, is a schematic block diagram of an exemplary ODF 500 by which the present inventive concept can be embodied. ODF 500 may include a user interface/formatter (UIF) 550 supported by mechanisms of ODF platform 110. Exemplary UIF 550 represents mechanisms deployed at and/or distributed over each user terminal 108, server 102 and decentralized online ecosystem 104 by which users 170 can select options, form communities, engage in token-based transactions, visualize results, etc. For example, user interface 109, as above, may be implemented as a component of platform client 142 at each user terminal 108, user interface 109 having user interface controls, such as those described above.

For purposes of demonstration and not limitation, it is to be assumed that a group of users of ODF 500 agree to establish a paid house 510 in which comedians can perform for and interact with a community of users, representatively illustrated at audience 526, in a virtual venue 520 constructed within paid house 510. In the illustrated example, audience 526 may include users that paid a membership fee and were issued a membership token in response thereto as described above. Platform members 506 of ODF 500 that are not members of paid house 510 but are invited to join a particular event/conversation, or that have purchased a ticket into virtual venue 520 for the particular event/conversation. When the founders 504 create paid house 510 on ODF 500, ODF 500 will automatically, i.e., without further user intervention, establish a DAO 525 within ODF 500 having its organization defined and management functions implemented in a smart contract 540. However, it is also possible for business management functionality of paid house 510 to be implemented in a centralized manner using techniques other than a DAO.

Through a sequenced set of data entry interface controls presented to founders 504 similar to those described with reference to FIG. 3, DAO formation component 552 of UIF 550 may build smart contract 540 from information entered by each founder 504 at respective user terminals 108 combined with data contained in one or more smart contract shells, templates, plugins 502 encompassing, among other things, source code for virtual machine executable management functions, different smart contract options establishing execution conditions/thresholds in response to which the virtual machine executable management functions are executed by virtual machine 135. Once the appropriate smart contract shell 502 and other smart contract options have been selected, DAO formation component 552 may assemble the entered data and applicable smart contract shell 502, may compile, where necessary, source code included in one or more of the shells 502 into bytecode, and may submit the resulting smart contract 540 to virtual machine 135 for recording into distributed ledger 156.

As illustrated in FIG. 5, users of ODF 500 may be associated with respective crypto wallet(s) 505 associated with respective founder(s) 504, crypto wallet(s) 507 associated with platform member(s) 506, crypto wallet(s) 524 associated with 3^{rd} party content provider(s) 522 and crypto wallet(s) 528 associated with audience member(s)/participant(s) 526. Additionally, ODF 500 may include one or more gas wallets 590 from which gas may be paid in meta-transactions, such as those described below with reference to FIGS. 6 and 7. DAO formation component 552 may be provided cryptographic keys from crypto wallets 505 for every founder 504 of paid house 210, such as for digitally signing approval of contract terms established over phases of building smart contract 540 for DAO 510. DAO formation component 552 may be constructed or otherwise configured to establish DAO 525 in ODF 500, including, among other things, funding DAO treasury 570, distributing and/or exchanging fungible and non-fungible tokens in transactions using crypto wallet(s) 505 and storing smart contract 540 on a distributed ledger 156, such as blockchain. Once DAO 525 becomes active, users may transact with paid house 510 through logical operations 542 defined in smart contract 540, where the logical operations 542 include conditional execution of actions selected by founders 204.

One exemplary feature that can be implemented in embodiments of the inventive concept is the acceptance of paid membership into paid house 510. In the comedy club example, each of platform members 506 might purchase, for example, one or more performance packages, each priced according to the number of performances included in the package. Moreover, each package offering may include voting rights in DAO 525, such as for selecting performers for future shows, as exemplified below. For membership, UIF 550 may have a membership component 554 through which a potential member from platform members 506 may be directed to enter member-related data through platform client 142, from which membership component 554 may format/compile, where necessary, a proposal 562 that is compliant with the instruction set architecture of virtual machine 135. Membership component 554 may be constructed or otherwise configured to convey proposal 562 to virtual machine 135 where it is evaluated against logical operations 542 established in smart contract 540 by founders 504. Proposal 562 may have encoded thereon, for example, a membership package selection that matches a trigger condition in logical operations 542 of smart contract 540, and a wallet address of wallet 507 of the potential paid house members from platform members 506. The action associated with the trigger condition, e.g., the selection of a membership package, may then be executed by virtual machine 135. As one example, the action may include compelling UIF 550 to display a membership fee associated with the selected package and a control by which potential member 506 can optionally assent to paying the displayed membership fee. In response to such assent, membership component may construct a proposal 562 from, for example, smart contract shells, templates, plugins 502, sign proposal 562 using the private key of potential member 506, and provide the signed proposal to smart contract 540, where a logical operation 542 therein may trigger the transfer of operational control to vote component 559 of UIF 550.

Voting amongst founders and voting members of paid house 510 may be achieved through a voting process executed by vote component 559. When initiated, vote component 559 may compel UIF 550 to display a vote control on user interface 109 through the corresponding platform client 142 at the relevant user terminals 108 that is appropriate to the subject of the vote. Vote component 556 may tally votes entered through the vote controls of participating voters, which may include weighting votes according to the number of membership tokens 568 under the control of the different voters. Moreover, vote component 559 may be constructed or otherwise configured to override votes of other voting members of paid house 510 at the behest of one or more founders 504.

In the membership case, vote component 559 may compel UIF 550 to display user information for potential member 506 on user interface 109 of voting members and a control to allow or deny membership into paid house 510. Approval of the membership through vote component 559 may meet a condition in logical operations 542 of smart contract 540, the corresponding action of which may include paying the membership fee to DAO treasury 270 using potential member's 506 crypto wallet 507.

According to its formation articles encoded in smart contract 540, DAO embodiments of the inventive concept may allow solicitation by potential performers, representatively illustrated at 3^{rd} party content provider 522, for gigs in virtual venue 520. For example, 3^{rd} party content provider 522 may be equipped with a user terminal 108 executing platform client 142. A content component 556 in UIF 550 may compel displaying and enabling controls by which 3^{rd} party content provider 522 can craft an offer of work using performer data and suitable templates 502. The offer of work may be formatted and compiled, where necessary, into a proposal 564 that can be evaluated against logical operations 542 in smart contract 540. One action that might be performed in response to corresponding conditions of smart contract 540 being met is to transfer operational control to vote component 559, by which founders 504 and other voting members can vote on proposal 564. Upon assent by a quorum, another logical operation 542 may be triggered in smart contract 540 that schedules a time and date for the performance. Sometime after the performance, 3^{rd} party content provider 522 may interact with content component 556 to build an invoice that is ultimately displayed by UIF 550 on user terminals 108 of founders 504 and other voting members. Operational control of UIF 550 may be transferred to vote component 559, which may compel a vote of approval of the invoice. If approved by a quorum, the invoice may be paid through a transaction between DAO treasury 570 and wallet 524 of 3^{rd} party content provider 522.

As illustrated in FIG. 2, virtual venue 520 may be constructed or otherwise configured to provide an environment suitable for the performance of 3^{rd} party content provider in front of audience/participant(s) 526. Accordingly, UIF 550 may include a ticket component 558 by which audience/participant(s) 526 can select from among different performers, different showtimes, etc. Upon such a selection, ticket component 558 may construct a suitable proposal 566 that can be evaluated against logical operations 542 of smart contract 540. Upon approval of a ticket purchase proposal 566 at user terminal 108, ticket component 558 may conduct a ticket purchase transaction between crypto wallet 528 of the purchasing audience/participant 526 and DAO treasury 270 according to proposal 566. A logical operation 542 of smart contract5240 that is responsive to the acknowledged purchase may compel the issuance of an attendance token 543 granting access to virtual venue 520 at the selected showtime.

Embodiments of the inventive concept may allow token transfers between DAO treasury 570 and platform treasury 580 according to terms established in smart contract 540. For example, operators of ODF platform 110 may expect a percentage stake in every paid house 510 constructed on the platform. When so embodied, a logical operation 542 in smart contract 540 may be triggered at every ticket sale by which the platform operator's stake is transferred from DAO treasury 570 to platform treasury 580. Additionally, transaction fees referred to as gas and payable to miners/minters of distributed ledger 156 may be withdrawn from a crypto wallet 290 designated specifically for paying gas in meta-transactions, such as those described with reference to FIGS. 7 and 8.

FIG. 6 is a schematic block diagram of an exemplary ODF platform 600 by which the present general inventive concept can be embodied. As indicated above, paid houses that operate on ODF platform 600 may have a treasury that is under collective control by designated house administrators 620. Accordingly, embodiments of the present inventive concept may comprise mechanisms by which a paid house treasury is funded as well as mechanisms by which collective control over the treasury is asserted. The present inventive concept is practicable through different variants of these mechanisms.

In the example of FIG. 6, treasury access gateway 630 may be a collection of hardware and software by which only those transactions with business entity treasury 635 that are approved by consensus, quorum or other consent vehicle of authorized administrators 620. One such treasury access gateway 630 may be the previously described smart contract, representatively illustrated in FIG. 6 at smart contract 630′, whereby a business entity treasury 635, such as the previously described DAO treasury wallet representatively illustrated in FIG. 6 at DAO wallet 635′, can be accessed for transactions only upon results of a vote by house administration 625, for example, that is entirely controlled through contract terms established in processor executable code of smart contract 630′.

As further exemplified in FIG. 6, platform members, representatively illustrated at platform member 610, may establish respective user financial accounts, representatively illustrated user financial account 615, that may indicate an account balance and that may allow platform administration 660 to conduct transactions on the platform member's 610 behalf. One example of such user financial accounts 615 may be the previously described crypto wallets, representatively illustrated at crypto wallet 615′, which, as explained above, can be easily created for the platform member 610 by embodiments of the present inventive concept.

House administration component 625 may be implemented through a combination of hardware and software to interoperate with treasury access gateway 630 in a way that prohibits any transaction from business entity treasury 635 other than those that have been approved, as agreed to by a previous engagement, by house administrators 620. As demonstrated above, interactions of house administration component 625 with a smart contract 630′ meet this condition, although other techniques for negotiating and/or approving expenditures from business entity treasury 635 may be used in embodiments of the present inventive concept without departing from the spirit and intended scope thereof.

Treasury funding may occur through different funding channels per any constraints imposed by, for example, the architecture, operating principles and tokenization of business entity treasury 635. For example, as discussed above, platform members 610 may purchase shares in the business entity, such as by a cryptocurrency transaction between the platform member's 610 crypto wallet 615′ and DAO wallet 635′ through smart contract 630′. This technique may also include the issuance of tokens that are distributed among house administrators 620 to define how votes from different house administrators 620 are weighted, as described above. Additionally, platform administration 660 may provide initial funding of business entity treasury 635 per a funding agreement, including promotional agreements intended to generate interest in paid houses on the ODF platform. Platform administration component 660 may be implemented through a combination of hardware and software to carry out administrative functions of the ODF platform, as opposed to administrative functions of the business entity, towards realizing a paid house. As such, platform administration component 660 may have access to business entity treasury 635 that is outside treasury access gateway 630 so that various activities, such as initial funding of business entity treasury 635, can be carried out without explicit approval by house administrators 620.

Another exemplary funding mechanism may be sourced from software sales, such as from the revenue generated from purchases of an app 650 through which platform member 610 interacts with other members of ODF platform 600. For example, app 650 or, more aptly, a user license for app 650, may be offered for sale on a digital distribution (DD) platform 640, e.g., APPLE APP STORE, GOOGLE PLAY, etc., for a price 642. DD platform administration component 645 may be implemented through a combination of hardware and software to manage sale and distribution of software offered thereon, including taking a share of price 642 and conveying the remainder of price 642 to the license grantor, e.g., platform administrators operating platform administration component 660. In certain embodiments, the revenue generated through software sales may be held in platform treasury 670 and distributed among paid houses created on ODF platform 600 according to previously established rules that may also accord increased voting rights (weight) among members of individual paid houses. In some embodiments, the generated revenue may undergo tokenization, such as to conform to transaction protocols of ODF platform 600. To that end, ODF platform 600 may include or otherwise be in communication with an exchange platform 680 through which fiat currency obtained from DD platform 640 may be converted to a chosen token. Embodiments of the present inventive concept may accommodate the use of stablecoin, i.e., tokens having an exchangeable value that is tied to fiat currencies, such as United States Digital Coin (USDC) that is tied to the US dollar. However, as demonstrated above, other tokenization may be used in conjunction with embodiments of the present inventive concept.

As illustrated in FIG. 6, app 650 may be a deliverable software package comprising platform client 654 and setup code/data 652. Platform client 654 may be fulfilled by the exemplary platform client 142 described above to afford member interactions, e.g., online discussions, financial transactions, etc. Setup code/data 652 may implement installation procedures by which platform client 654 is made usable on a user terminal of platform member 610. In certain embodiments, different versions of app 650 may be offered on DD platform 640 and setup code/data 652 may impose limitations on or assign special privileges to platform members 610 based on the price 642 paid thereby for app 650. For example, one version of app 650 may be offered gratis or free of license fees while another version of app 650 may be offered for, say, $5.00. Users of free versions of app 650 may establish a paid house on ODF platform 600 as described above, while users who paid a license fee may have, for example, special voting rights, a greater revenue share, of paid houses they create. Under this exemplary scheme, different purchase levels as defined by price 642 may be employed with each level being associated with a corresponding set of paid house privileges.

FIG. 7 is a sequence diagram of an exemplary meta-transaction 700 that can be performed by which embodiments of the present invention may be embodied. Various of smart contract/distributed ledger services 137 require users to pay a transaction fee, which, as indicated above, is referred to in the technical field as gas. When a user-selected action requires execution time on virtual machine 135, such as to send cryptocurrency to other users or to interact with smart contracts, gas must be paid to volunteer miners/minters who ensure security and proper operation and maintenance of the network on which the distributed/decentralized transactions are executed. But paying gas is an extra operation of a transaction that may feel intrusive to a user expecting a seamless user experience. Moreover, a first-time cryptocurrency user is unlikely to have a cryptocurrency balance in their wallet and, as such, are unable to pay gas. The process of buying crypto tokens from a fiat-to-crypto exchange is cumbersome and makes for a bad first-time user experience. Meta-transactions overcome these issues without compromising a seamless user experience by allowing a third party, e.g., one outside the transaction, to pay gas on a transaction that was signed by a user that is party to the transaction.

As illustrated in FIG. 7, a user at user terminal 710 may select an action (e.g., join paid community, cast vote etc.) through user controls of platform client 142 and an indication of the selected action may be conveyed to platform servers 730 in a suitable message 712. Platform servers 730 may configure a transaction suitable for execution by virtual machine 135 and may store information regarding the transaction in memory circuitry 130 in operation 732. Platform servers 730 may start a transaction expiry timer 180 in operation 716 and may also return a configured transaction corresponding to the selected action to user terminal 710 in a suitable message 734. Here, embodiments of the inventive concept may, in operation 736, consult the transaction expiry timer 180 as to whether it has expired. If the transaction is signed with the user's private key prior to expiration of the transaction expiry timer 180, the signed transaction may be conveyed to platform servers 730 in a suitable message 718. However, if the transaction expiry timer 180 expires before the transaction is signed, the transaction is terminated and an indication that the transaction is rejected may be conveyed to user terminal 610 in a suitable message 738.

For the transactions that are signed prior to expiration of the transaction expiry timer 180, the signed transaction may be conveyed from platform servers 730 to a gas relay 760 in a suitable message 718. In certain implementations, the stored transaction information 732 may be compared with the transaction information of the transaction presented for signature. If the two sets of information differ, the transaction is terminated and an indication that the transaction is rejected may be conveyed to user terminal 610 in a suitable message 739.

Gas relay 760 may be constructed or otherwise configured to accept payment of gas by a party that is apart from the targeted end-parties of the transaction. For example, gas relay 760 may estimate gas based on a known pricing scheme, such as execution time for the transaction to be completed by virtual machine 135. The estimate along with information regarding gas wallet 290 may be conveyed from gas relay 760 to virtual machine 780 in a suitable message 762 and virtual machine 780 may conduct the transaction using gas pointed to by gas wallet 290. In one aspect, the signed transaction and the gas fee are wrapped in a second signed transaction, and the second signed transaction is sent to a smart contract that will cause the vote to be recorded on the blockchain and the gas to be paid using the gas included in the second signed transaction. Additionally, gas relay 760 may convey a suitable message 764 to platform servers 730 acknowledging that the transaction was conveyed to virtual machine 780. In turn, platform servers 730 may convey acknowledgment that the action was completed in a suitable message 750.

FIG. 8 is a flow diagram of an exemplary meta-transaction process 800 by which embodiments of the present invention may be embodied. In operation 805, process 800 may await selection of an action from a user and, in response to such selection, process 800 may transition to operation 810, by which an indication of the selected action along with any supporting data required to complete the action are conveyed from platform client 142 at user terminal 108 to discussion platform 122 and decentralized network component 124 on server 102. In operation 815, ODF platform 110 may configure and store transaction data, such as a user identifier and a transaction identifier. In operation 820, ODF platform 110 may start transaction expiry timer 180 and, in operation 825, the transaction data may be conveyed from ODF platform 110 to user terminal 108. Process 800 may transition to operation 830 at which it is determined whether transaction information presented for signature is the same transaction information produced by operation 815. If not, process 800 may transition to operation 831, by which the transaction is terminated. If, however, it is determined in operation 831 that the transaction information is accurate, process 800 may transition to operation 833 by which it is determined whether the transaction has been signed by the transaction originator. By way of operation 870 in which the transaction expiry timer 180 is consulted and the loop thereof with operation 833, process 800 remains in that loop until either expiration of the transaction expiry timer 180 or until the transaction is signed by the transaction originator. If the transaction expiry timer 180 lapses, process 800 may transition to operation 875 by which the transaction is terminated and, in operation 880, the termination is reported to the appropriate user terminal 108.

If the transaction is signed before lapsing of transaction expiry timer 180, as determined in operation 830, process 800 may transition to operation 835 by which the signed transaction is conveyed from user terminal 108 to gas relay 660 through ODF platform 110. In operation 840, gas may be calculated at gas relay 760 and the calculated gas may be paid to the miner/minter from gas wallet 290 in operation 845. In operation 850, the transaction is mined/minted into a block and recorded in distributed ledger 156. In operation 855, acknowledgment of conveyance of the transaction to virtual machine 135 from gas relay 760 is conveyed to ODF platform 110 and, in operation 860, an indication that the selected action has been completed is conveyed to user terminal 108.

Certain embodiments of the present general inventive concept provide for the functional components to manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the computer-readable medium.

It is to be understood that the computer-readable medium described above may be any non-transitory medium on which the instructions may be encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. An online discussion forum (ODF) system, comprising:
processing circuitry configured to
accept a command from a platform client to create a community on the ODF that allows members of the community who pay a membership fee to access content, the platform client being one of a plurality of platform clients that are associated with a corresponding plurality of user terminals, the platform client providing access for ODF participants to interact with the online discussion forum,
in response to accepting the command to create the community
create and deploy a smart contract to a blockchain that establishes a decentralized autonomous organization (DAO) associated with the community with at least one of the ODF participants identified as a managing member, and
associate a treasury with the DAO into which payments of the membership fee are deposited,
receive a proposal from one of the platform clients to make a payment from the treasury to a recipient,
in response to receiving the proposal to make a payment from the treasury to the recipient, send, to the platform client of the managing member of the DAO, a request for a vote on whether to approve the proposal,
receive a reply message containing information on the vote from the platform client of the managing member, and
determine whether to make the payment according to the proposal based on the vote.

2. The ODF system of claim 1, wherein the processing circuitry is further configured to
distribute ownership tokens to blockchain wallet addresses associated with managing members of the DAO,
wherein the determination whether to make the payment according to the proposal based on the vote includes taking into account the proportion of ownership tokens held at the respective blockchain wallet addresses of each of the managing members.

3. The ODF system of claim 2, wherein the vote is a transaction recorded on a blockchain that incurs a gas fee and the processing circuitry is further configured to
store transaction information corresponding to the vote;
send the transaction corresponding to the vote to the platform client of the voting managing member for cryptographic signature;
determine whether a signed transaction is received from a platform client of a managing member participating in the vote;
in response to a determination that the signed transaction is received, determine whether the signed transaction is defective; and
in response to a determination that the signed transaction is not defective, calculate the gas fee for recording the vote on the blockchain and pay the gas fee from a blockchain wallet that is not owned by the voting managing member.

4. The ODF system of claim 3, wherein the processing circuitry is further configured to
send the transaction corresponding to the vote to the platform client of each of the ODF participants participating in the vote for cryptographic signature.

5. The ODF system of claim 4, wherein the processing circuitry is further configured to
start a timer with a transaction expiration time, and
in response to a determination that the signed transaction is received after the timer expires, discard the signed transaction prior to payment of the gas fee.

6. The ODF system of claim 5, wherein the processor circuitry is further configured to
in response to a determination that the signed transaction is defective, discard the signed transaction prior to payment of the gas fee.

7. The ODF system of claim 6, wherein the smart contract executes at an addressable location on the blockchain.

8. The ODF system of claim 3, wherein the signed transaction being defective includes the signed transaction being different than the transaction sent to the platform client.

9. The ODF system of claim 3, wherein in response to the determination that the signed transaction is not defective the processing circuitry is further configured to
wrap the signed transaction and the gas fee in a second signed transaction, and
send the second signed transaction to a smart contract that will cause the vote to be recorded on the blockchain and the gas to be paid using the gas included in the second signed transaction.

10. A method, comprising:
accepting a command from a platform client to create a community on an online discussion forum (ODF) that allows members of the community who pay a membership fee to access content, the platform client being one of a plurality of platform clients that are associated with a corresponding plurality of user terminals, the platform client providing access for ODF participants to interact with the online discussion forum;
in response to accepting the command to create the community
creating and deploy a smart contract to a blockchain that establishes a decentralized autonomous organization (DAO) associated with the community with at least one of the ODF participants identified as a managing member; and
associating a treasury with the DAO into which payments of the membership fee are deposited;
receiving a proposal from one of the platform clients to make a payment from the treasury to a recipient;
in response to receiving the proposal to make a payment from the treasury to the recipient, sending, to the platform client of the managing member of the DAO, a request for a vote on whether to approve the proposal;
receiving a reply message containing information on the vote from the platform client of the managing member; and
determining whether to make the payment according to the proposal based on the vote.

11. The method of claim 10, further comprising:
distributing ownership tokens to blockchain wallet addresses associated with managing members of the DAO,
wherein the determination whether to make the payment according to the proposal based on the vote includes taking into account the proportion of ownership tokens held at the respective blockchain wallet addresses of each of the managing members.

12. The method of claim 11, wherein the vote is a transaction recorded on a blockchain that incurs a gas fee, the method further comprising:
storing transaction information corresponding to the vote;
sending the transaction corresponding to the vote to the platform client of the voting managing member for cryptographic signature;
determining whether a signed transaction is received from a platform client of a managing member participating in the vote;
in response to a determination that the signed transaction is received, determine whether the signed transaction is defective; and
in response to a determination that the signed transaction is not defective, calculate the gas fee for recording the vote on the blockchain and pay the gas fee from a blockchain wallet that is not owned by the voting managing member.

13. The method of claim 12, further comprising:
sending the transaction corresponding to the vote to the platform client of each of the ODF participants participating in the vote for cryptographic signature.

14. The method of claim 13, further comprising:
starting a timer with a transaction expiration time; and
in response to a determination that the signed transaction is received after the timer expires, discarding the signed transaction prior to payment of the gas fee.

15. The method of claim 14, further comprising:
in response to a determination that the signed transaction is defective, discarding the signed transaction prior to payment of the gas fee.

16. The method of claim 15, wherein the smart contract executes at an addressable location on the blockchain.

17. The method of claim 12, wherein the transaction being defective includes the signed transaction being different than the transaction sent to the platform client.

18. The method of claim 12, further comprising:
wrapping the signed transaction and the gas fee in a second signed transaction; and
sending the second signed transaction to a smart contract that will cause the vote to be recorded on the blockchain and the gas to be paid using the gas included in the second signed transaction.

19. One or more computer readable medium including computer program instructions, which when executed by an information processing system, cause the system to:
accept a command from a platform client to create a community on the ODF that allows members of the community who pay a membership fee to access content, the platform client being one of a plurality of platform clients that are associated with a corresponding plurality of user terminals, the platform client providing access for ODF participants to interact with the online discussion forum,
in response to accepting the command to create the community
create and deploy a smart contract to a blockchain that establishes a decentralized autonomous organization (DAO) associated with the community with at least one of the ODF participants identified as a managing member, and
associate a treasury with the DAO into which payments of the membership fee are deposited,
receive a proposal from one of the platform clients to make a payment from the treasury to a recipient,
in response to receiving the proposal to make a payment from the treasury to the recipient, send, to the platform client of the managing member of the DAO, a request for a vote on whether to approve the proposal,
receive a reply message containing information on the vote from the platform client of the managing member, and
determine whether to make the payment according to the proposal based on the vote.

20. The one or more computer readable medium of claim 19, wherein the information processing system is a mobile device or a server.
